(19) United States
(12) Patent Application Publication
(10) Pub. No.: US 2025/0029173 A1
(43) Pub. Date: Jan. 23, 2025

(54) MEAL PLANNING USER INTERFACE WITH LARGE LANGUAGE MODELS

(71) Applicant: Maplebear Inc., San Francisco, CA (US)

(72) Inventors: Riddhima Sejpal, Dublin, CA (US); Luis Manrique, Joshua Tree, CA (US); Shiyun Lu, Washington, DC (US); Vikrant Verma, Millbrae, CA (US); Nicole Yin Chuen Lee Altman, Honolulu, HI (US)

(21) Appl. No.: 18/771,748

(22) Filed: Jul. 12, 2024

Related U.S. Application Data
(60) Provisional application No. 63/527,299, filed on Jul. 17, 2023.

(51) Int. Cl. G06Q 30/0601

(52) U.S. Cl. CPC G06Q 30/0643; G06Q 30/0631; G06Q 30/0635

(57) ABSTRACT

An online system leverages a machine-learning model to craft personalized meal plans for users. The system generates and presents an interface displaying categories of user preferences. The system receives, from the user via the interface, user preferences for the meal plan. The system generates a prompt including a request to generate the meal plan for the user and the user preferences. The system provides the prompt to the machine-learning model and receives, as output, a meal plan that comprises a list of meals and a list of ingredients for each meal. The system presents the meal plan to the user. The system receives user input to add ingredients to an order and generates an order including the lists of ingredients corresponding to the selected meals.

### CROSS-REFERENCE TO RELATED APPLICATIONS

The present application claims the benefit of and priority to U.S. Provisional Application No. 63/527,299, filed on Jul. 17, 2023, which is incorporated by reference.

### BACKGROUND

The user of today has many choices and options for various ingredients, recipes, and meals. However, it is still up to the user to make all of the choices required for selecting and organizing a meal plan and determining how to source the various ingredients required. Some difficult-to-find ingredients may be a key item to the recipe, such that if the user cannot obtain that key item, the recipe would be severely lacking. To circumvent these issues, the user may opt for meal plans that are simple and repetitive. While there are existing meal planning applications or solutions, these applications do not take into account personalized preferences, restrictions, and the like of users, and thus, do not personalize the meal plan and also do not consider inventory data from retailers.

### SUMMARY

In accordance with one or more aspects of the disclosure, an online system generates an interface for presentation to a user of the online system. The interface displays one or more categories of preferences for the user for a personalized meal plan for the user. The online system receives, from the user, a set of user preferences for the personalized meal plan via the interface. In some embodiments, the online system may further receive information on items added into a user's cart and/or a user's order, which may be used to further inform the personalized meal plan.

The online system generates a prompt for execution by a machine-learned model, the prompt including at least a request to generate the personalized meal plan for the user and the set of user preferences as contextual information. The online system provides the prompt to the machine-learning model. The online system receives, as output from the machine-learning model, a personalized meal plan that includes a list of meals for the user to consume during a duration of time and for each meal, a list of ingredients for making the meal. The online system generates recipes for making the list of meals based on the list of ingredients for the list of meals. The online system provides, to the user, the personalized meal plan. The online system, responsive to a user selection of a meal, presents an ordering interface displaying at least one retailer and a list of items for the retailer, where the list of items for the retailer corresponds to the list of ingredients for the personalized meal plan for the user to order. Via the ordering interface, the user may add items to an order, e.g., for fulfillment by the online system.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is a block diagram for a method of meal planning, in accordance with some embodiments.

FIGS. 4A-4F illustrate example user interfaces presented by an online system for meal planning, in accordance with some embodiments.

FIG. 5 is a flowchart for a method of meal planning, in accordance with some embodiments.

### DETAILED DESCRIPTION

### System Environment

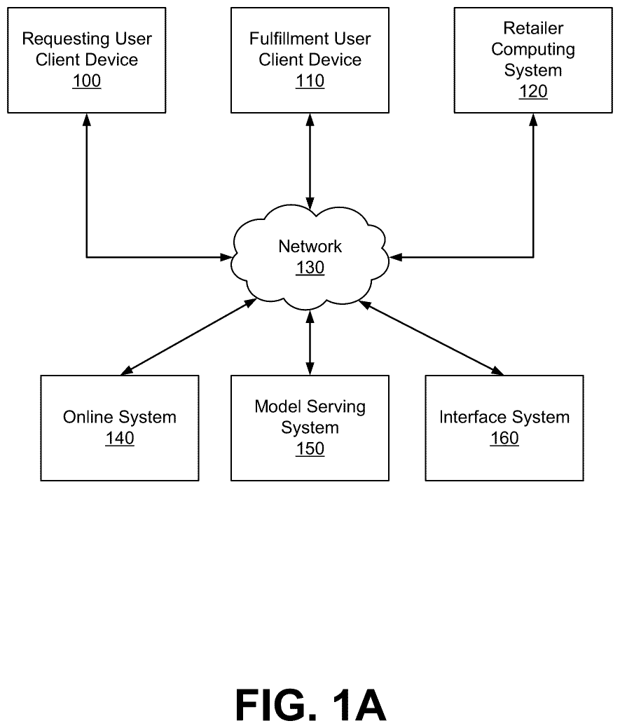

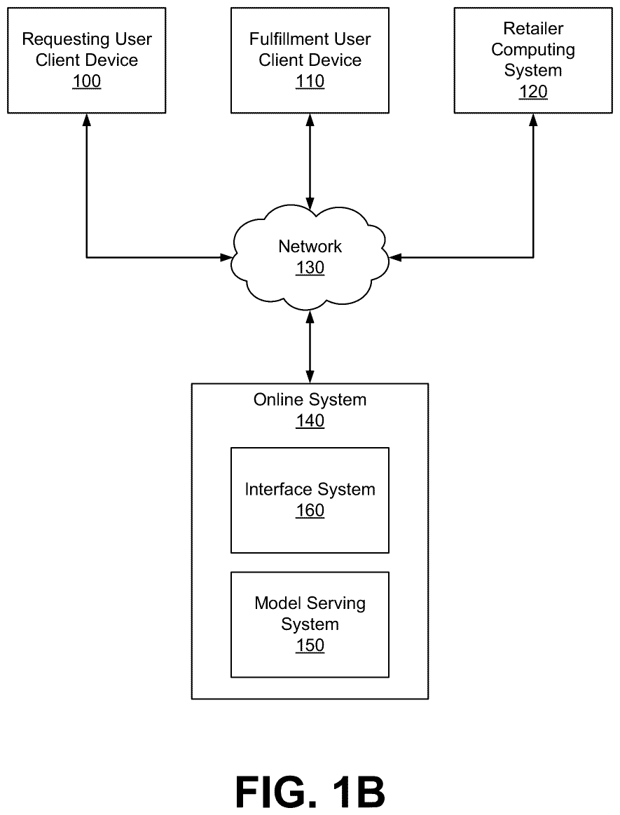

FIG. 1A illustrates an example system environment for an online system 140, in accordance with one or more embodiments. The system environment illustrated in FIG. 1A includes a requesting user client device 100, a fulfillment user client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, requesting users, fulfillment users, and retailers may be generically referred to as “users” of the online system 140. Additionally, while one requesting user client device 100, fulfillment user client device 110, and retailer computing system 120 are illustrated in FIG. 1, any number of requesting users, fulfillment users, and retailers may interact with the online system 140. As such, there may be more than one requesting user client device 100, fulfillment user client device 110, or retailer computing system 120.

The requesting user client device 100 is a client device through which a requesting user may interact with the fulfillment user client device 110, the retailer computing system 120, or the online system 140. The requesting user client device 100 can be a personal or mobile computing device, such as a smartphone, a tablet, a laptop computer, or desktop computer. In some embodiments, the requesting user client device 100 executes a client application that uses an application programming interface (API) to communicate with the online system 140.

A requesting user uses the requesting user client device 100 to place an order with the online system 140. An order specifies a set of items to be delivered to the requesting user. An “item”, as used herein, means a good or product that can be provided to the requesting user through the online system 140. The order may include item identifiers (e.g., a stock keeping unit (SKU) or a price look-up code) for items to be delivered to the user and may include quantities of the items to be delivered. Additionally, an order may further include a delivery location to which the ordered items are to be delivered and a time frame during which the items should be delivered. In some embodiments, the order also specifies one or more retailers from which the ordered items should be collected.

The requesting user client device 100 presents an ordering interface to the requesting user's client device ex 100. The ordering interface is a user interface that the requesting user can use to place an order with the online system 140. The ordering interface may be part of a client application operating on the requesting user client device 100. The ordering interface allows the requesting user to search for items that are available through the online system 140 and the requesting user can select which items to add to a “shopping list.” A “shopping list,” as used herein, is a tentative set of items that the user has selected for an order but that has not yet been finalized for an order. The ordering interface allows a requesting user to update the shopping list, e.g., by changing the quantity of items, adding or removing items, or adding instructions for items that specify how the item should be collected.

The requesting user client device 100 may receive additional content from the online system 140 to present to the requesting user. For example, the requesting user client device 100 may receive coupons, recipes, or item suggestions. The requesting user client device 100 may present the received additional content to the requesting user as the requesting user uses the requesting user client device 100 to place an order (e.g., as part of the ordering interface).

Additionally, the requesting user client device 100 includes a communication interface that allows the requesting user to communicate with a fulfillment user that is servicing the requesting user's order. This communication interface allows the user to input a text-based message to transmit to the fulfillment user client device 110 via the network 130. The fulfillment user client device 110 receives the message from the requesting user client device 100 and presents the message to the fulfillment user. The fulfillment user client device 110 also includes a communication interface that allows the fulfillment user to communicate with the requesting user. The fulfillment user client device 110 transmits a message provided by the fulfillment user to the requesting user client device 100 via the network 130. In some embodiments, messages sent between the requesting user client device 100 and the fulfillment user client device 110 are transmitted through the online system 140. In addition to the text messages, the communication interfaces of the requesting user client device 100 and the fulfillment user client device 110 may allow the requesting user and the fulfillment user to communicate through audio or video communications, such as a phone call, a voice-over-IP call, or a video call.

The fulfillment user client device 110 is a client device through which a fulfillment user may interact with the requesting user client device 100, the retailer computing system 120, or the online system 140. The fulfillment user client device 110 can be a personal or mobile computing device, such as a smartphone, a tablet, a laptop computer, or desktop computer. In some embodiments, the fulfillment user client device 110 executes a client application that uses an application programming interface (API) to communicate with the online system 140.

The fulfillment user client device 110 receives orders from the online system 140 for the fulfillment user to service. A fulfillment user services an order by collecting the items listed in the order from a retailer. The fulfillment user client device 110 presents the items that are included in the requesting user's order to the fulfillment user in a collection interface. The collection interface is a user interface that provides information to the fulfillment user on which items to collect for a requesting user's order and the quantities of the items. In some embodiments, the collection interface provides multiple orders from multiple requesting users for the fulfillment user to service at the same time from the same retailer location. The collection interface further presents instructions that the requesting user may have included related to the collection of items in the order. Additionally, the collection interface may present a location of each item in the retailer location, and may even specify a sequence in which the fulfillment user should collect the items for improved efficiency in collecting items. In some embodiments, the fulfillment user client device 110 transmits to the online system 140 or the requesting user client device 100 which items the fulfillment user has collected in real time as the fulfillment user collects the items.

The fulfillment user can use the fulfillment user client device 110 to keep track of the items that the fulfillment user has collected to ensure that the fulfillment user collects all of the items for an order. The fulfillment user client device 110 may include a barcode scanner that can determine an item identifier encoded in a barcode coupled to an item. The fulfillment user client device 110 compares this item identifier to items in the order that the fulfillment user is servicing, and if the item identifier corresponds to an item in the order, the fulfillment user client device 110 identifies the item as collected. In some embodiments, rather than or in addition to using a barcode scanner, the fulfillment user client device 110 captures one or more images of the item and determines the item identifier for the item based on the images. The fulfillment user client device 110 may determine the item identifier directly or by transmitting the images to the online system 140. Furthermore, the fulfillment user client device 110 determines a weight for items that are priced by weight. The fulfillment user client device 110 may prompt the fulfillment user to manually input the weight of an item or may communicate with a weighing system in the retailer location to receive the weight of an item.

When the fulfillment user has collected all of the items for an order, the fulfillment user client device 110 instructs a fulfillment user on where to deliver the items for a requesting user's order. For example, the fulfillment user client device 110 displays a delivery location from the order to the fulfillment user. The fulfillment user client device 110 also provides navigation instructions for the fulfillment user to travel from the retailer location to the delivery location. Where a fulfillment user is servicing more than one order, the fulfillment user client device 110 identifies which items should be delivered to which delivery location. The fulfillment user client device 110 may provide navigation instructions from the retailer location to each of the delivery locations. The fulfillment user client device 110 may receive one or more delivery locations from the online system 140 and may provide the delivery locations to the fulfillment user so that the fulfillment user can deliver the corresponding one or more orders to those locations. The fulfillment user client device 110 may also provide navigation instructions for the fulfillment user from the retailer location from which the fulfillment user collected the items to the one or more delivery locations.

In some embodiments, the fulfillment user client device 110 tracks the location of the fulfillment user as the fulfillment user delivers orders to delivery locations. The fulfillment user client device 110 collects location data and transmits the location data to the online system 140. The online system 140 may transmit the location data to the requesting user client device 100 for display to the requesting user such that the requesting user can keep track of when their order will be delivered. Additionally, the online system 140 may generate updated navigation instructions for the fulfillment user based on the fulfillment user's location. For example, if the fulfillment user takes a wrong turn while traveling to a delivery location, the online system 140 determines the fulfillment user's updated location based on location data from the fulfillment user client device 110 and generates updated navigation instructions for the fulfillment user based on the updated location.

In one or more embodiments, the fulfillment user is a single person who collects items for an order from a retailer location and delivers the order to the delivery location for the order. Alternatively, more than one person may serve the role as a fulfillment user for an order. For example, multiple people may collect the items at the retailer location for a single order. Similarly, the person who delivers an order to its delivery location may be different from the person or people who collected the items from the retailer location. In these embodiments, each person may have a fulfillment user client device 110 that they can use to interact with the online system 140.

Additionally, while the description herein may primarily refer to fulfillment users as humans, in some embodiments, some or all of the steps taken by the fulfillment user may be automated. For example, a semi- or fully autonomous robot may collect items in a retailer location for an order and an autonomous vehicle may deliver an order to a requesting user from a retailer location.

The retailer computing system 120 is a computing system operated by a retailer that interacts with the online system 140. As used herein, a “retailer” is an entity that operates a “retailer location,” which is a store, warehouse, or other building from which a fulfillment user can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The requesting user client device 100, the fulfillment user client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which requesting users can order items to be provided to them by a fulfillment user from a retailer. The online system 140 receives orders from a requesting user client device 100 through the network 130. The online system 140 selects a fulfillment user to service the requesting user's order and transmits the order to a fulfillment user client device 110 associated with the fulfillment user. The fulfillment user collects the ordered items from a retailer location and delivers the ordered items to the requesting user. The online system 140 may charge a requesting user for the order and provides portions of the payment from the requesting user to the fulfillment user and the retailer.

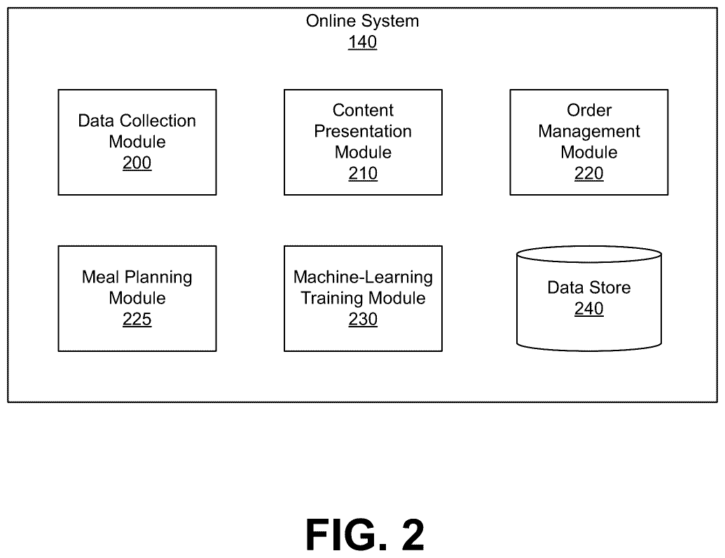

As an example, the online system 140 may allow a requesting user to order groceries from a grocery store retailer. The requesting user's order may specify which groceries they want delivered from the grocery store and the quantities of each of the groceries. The requesting user's client device 100 transmits the requesting user's order to the online system 140 and the online system 140 selects a fulfillment user to travel to the grocery store retailer location to collect the groceries ordered by the requesting user. Once the fulfillment user has collected the groceries ordered by the requesting user, the fulfillment user delivers the groceries to a location transmitted to the fulfillment user client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the online system 140 provides instructions for generating a user interface (UI) on a client device 110 for synthesizing a meal plan for a user. The online system 140 prompts a machine-learned model to prepare a personalized meal plan for the user. Specifically, the online system 140 generates a prompt for input to the model serving system 150. The prompt may include a query to generate a customized meal plan for an individual based on user preferences, other contextual information, or some combination thereof. The online system 140 receives a response to the prompt from the model serving system 150 based on execution of the machine-learned model using the prompt. The online system 140 obtains the response and determines a list of recipes for a personalized meal plan based on the response. The online system 140 may present the personalized meal plan with the list of recipes to the user. In response, the user may select one or more of the recipes. Based on the selection, the online system 140 presents an ordering interface for the user displaying at least one retailer and a list of items for the retailer, based on the personalized meal plan.

In some embodiments, the user may provide input requesting one or more modifications to a recipe or to the personalized meal plan. In response, the online system 140 may generate a subsequent prompt including the recipe and/or the personalized meal plan to be modified and the one or more modifications provided by the user. The online system 140 may provide the subsequent prompt for input to the model serving system 150. The online system 140 receives a subsequent response to the subsequent prompt from the model serving system 150 based on execution of the machine-learning model using the subsequent prompt. The online system 140 may determine the modified personalized meal plan and/or the modified recipe based on the subsequent response.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a requesting user client device 100, a fulfillment user client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

### Online System Architecture

FIG. 2 illustrates an example system architecture for an online system 140, in accordance with some embodiments. The system architecture illustrated in FIG. 2 includes a data collection module 200, a content presentation module 210, an order management module 220, a meal planning module 225, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects requesting user data, which is information or data that describe characteristics of a requesting user. Requesting user data may include a requesting user's name, address, shopping preferences, favorite items, or stored payment instruments. The requesting user data also may include default settings established by the requesting user, such as a default retailer/retailer location, payment instrument, delivery location, or delivery timeframe. The data collection module 200 may collect the requesting user data from sensors on the requesting user client device 100 or based on the requesting user's interactions with the online system 140.

The data collection module 200 collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a fulfillment user looked for the item but could not find it), the rate at which the item is found, or the popularity of the item. The data collection module 200 may collect the item data from a retailer computing system 120, a fulfillment user client device 110, or the requesting user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 collects fulfillment user data, which are information or data that describes characteristics of fulfillment users. For example, the fulfillment user data for a fulfillment user may include the fulfillment user's name, the fulfillment user's location, how often the fulfillment user has services orders for the online system 140, a requesting user rating for the fulfillment user, which retailers the fulfillment user has collected items at, or the fulfillment user's previous shopping history. Additionally, the fulfillment user data may include preferences expressed by the fulfillment user, such as their preferred retailers to collect items at, how far they are willing to travel to deliver items to a requesting user, how many items they are willing to collect at a time, time frames within which the fulfillment user is willing to service orders, or payment information by which the fulfillment user is to be paid for servicing orders (e.g., a bank account). The data collection module 200 collects fulfillment user data from sensors of the fulfillment user client device 110 or from the fulfillment user's interactions with the online system 140.

Additionally, the data collection module 200 collects order data, which is information or data that describes characteristics of an order. For example, order data may include item data for items that are included in the order, a delivery location for the order, a requesting user associated with the order, a retailer location from which the requesting user wants the ordered items collected, or a timeframe within which the requesting user wants the order delivered. Order data may further include information describing how the order was serviced, such as which fulfillment user serviced the order, when the order was delivered, or a rating that the requesting user gave the delivery of the order. In some embodiments, the order data includes user data for users associated with the order, such as requesting user data for a requesting user who placed the order or fulfillment user data for a fulfillment user who serviced the order.

The content presentation module 210 selects content for presentation to a user. For example, the content presentation module 210 selects which items to present to a requesting user while the requesting user is placing an order. The content presentation module 210 generates and transmits the ordering interface for the requesting user to order items. The content presentation module 210 populates the ordering interface with items that the requesting user may select for adding to their order. In some embodiments, the content presentation module 210 presents a catalog of all items that are available to the requesting user, which the requesting user can browse to select items to order. The content presentation module 210 also identifies items that the requesting user is most likely to order and present those items to the requesting user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a requesting user. An item selection model is a machine-learning model that is trained to score items for a requesting user based on item data for the items and requesting user data for the requesting user. For example, the item selection model may be trained to determine a likelihood that the requesting user will order the item. In some embodiments, the item selection model uses item embeddings describing items and requesting user embeddings describing requesting users to score items. These item embeddings and requesting user embeddings may be generated by separate machine-learning models and may be stored in the data store 240.

In some embodiments, the content presentation module 210 scores items based on a search query received from the requesting user client device 100. A search query is free text for a word or set of words that indicate items of interest to the requesting user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a requesting user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a retailer location. For example, the availability model may be trained to predict a likelihood that an item is available at a retailer location or may predict an estimated number of items that are available at a retailer location. The content presentation module 210 may weigh the score for an item based on the predicted availability of the item. Alternatively, the content presentation module 210 may filter out items from presentation to a requesting user based on whether the predicted availability of the item exceeds a threshold.

In some embodiments, the content presentation module 210 may present content based on a personalized meal plan for the requesting user on a client device 110 of the user. The content presentation module 210 may generate and present an interface including user-interactable elements for a user to provide input on preferences for crafting the personalized meal plan. The interface may include one or more tiles for displaying the user-interactable elements. Each tile occupies a portion of the user interface. In some embodiments, the tile may occupy the entire viewing window. In other embodiments, the tile may occupy some portion of the viewing window. Each tile may include a border, a background, other visually distinguishing features, or some combination thereof. In some embodiments, tiles may be collated to be viewed in a scrolling manner. In other embodiments, tiles may be swiped to remove presentation of one tile while displaying another tile. In other embodiments, tiles may be temporally sequential, i.e., a first tile displays for some period, then another tile displays following the first tile. In one or more embodiments, the interface may display a preference category including one or more selectable options under the category. The user may select from the options presented under the preference category. For example, the interface may query diet regimes and may include options for vegetarian, vegan, nut-free, paleo, keto, pescatarian, diary-free, etc. Based on the user's selections, the online system 140 may store the user preferences for the user, e.g., in a user profile.

In some embodiments, one or more categories may be automatically triggered based on prior selections in a prior category. For example, the interface may present a first tile indicating cuisines of different macro geographical regions (South American, North American, European, Mediterranean, Asian, African, etc.). Based on the user's selection, the interface may trigger a subsequent tile indicating cuisines of micro geographical regions (e.g., upon selection of Asian cuisine, the interface may present options for East Asian, Southeast Asian, South Asian, etc.). The content presentation module 210 may automatically trigger additional tiles indicating subcategories with increasing granularity. The content presentation module 210 may provide the user preferences received via the interface to inform meal planning.

The content presentation module 210 may also present the personalized meal plan (e.g., determined based on a response output based on execution of a machine-learning on the prompt) to the user. The personalized meal plan may include a list of meals, i.e., informed by the user preferences. The content presentation module 210 may present the meals for acceptance by the user. For example, the content presentation module 210 may present the meals as options for inclusion in the user's meal plan. The user may select one or more of the meals to include in their meal plan. In some embodiments, the interface may further include input options for inputting one or more modifications to a meal and/or the presented plan. For example, the user may request substitution of an ingredient, addition of an ingredient, removal of an ingredient, increasing portion size, etc. Based on the selected meals, the content presentation module 210 may aggregate a list of items to obtain for making the recipes. The items may be obtained by the user and/or added to an order for fulfillment by the online system 140 (e.g., assignment of the order to a fulfillment user to obtain the items at one or more retailer locations). In other embodiments, the content presentation module 210 may present, in the meal planning interface, the items for preparation of the meals in the personalized meal plan. The user may, via the meal planning interface, provide input to add one or more of the items to an order.

In some embodiments, the content presentation module 210 may present an interface following the user's preparation of meals from the personalized meal plan. The interface may request feedback on the recipe, the meal plan, the order fulfillment, etc. In one or more examples, the user may provide feedback that a recipe required more effort than expected. In one or more examples, the user may provide feedback that a recipe took a longer time than anticipated. In one or more examples, the user may provide an indication as to whether the user enjoyed one or more of the meals in the personalized meal plan. In one or more examples, the user may provide a rating to the meal. The ratings may be aggregated for the various recipes, e.g., to improve recipes, to present the ratings to other users when crafting personalized meal plans for those users, etc. The content presentation module 210 may store the feedback provided via the interface. The feedback may be used to update or add to the user preferences. In other embodiments, the online system 140 may leverage the feedback in training the one or more machine-learning models.

The order management module 220 that manages orders for items from requesting users of the online system 140. The order management module 220 receives orders from a requesting user client device 100 and assigns the orders to fulfillment users for service based on fulfillment user data. For example, the order management module 220 assigns an order to a fulfillment user based on the fulfillment user's location and the location of the retailer from which the ordered items are to be collected. The order management module 220 may also assign an order to a fulfillment user based on how many items are in the order, a vehicle operated by the fulfillment user, the delivery location, the fulfillment user's preferences on how far to travel to deliver an order, the fulfillment user's ratings by requesting users, or how often a fulfillment user agrees to service an order.

In some embodiments, the order management module 220 determines when to assign an order to a fulfillment user based on a delivery timeframe requested by the requesting user with the order. The order management module 220 computes an estimated amount of time that it would take for a fulfillment user to collect the items for an order and deliver the ordered item to the delivery location for the order. The order management module 220 assigns the order to a fulfillment user at a time such that, if the fulfillment user immediately services the order, the fulfillment user is likely to deliver the order at a time within the timeframe. Thus, when the order management module 220 receives an order, the order management module 220 may delay in assigning the order to a fulfillment user if the timeframe is far enough in the future.

When the order management module 220 assigns an order to a fulfillment user, the order management module 220 transmits the order to the fulfillment user client device 110 associated with the fulfillment user. The order management module 220 may also transmit navigation instructions from the fulfillment user's current location to the retailer location associated with the order. If the order includes items to collect from multiple retailer locations, the order management module 220 identifies the retailer locations to the fulfillment user and may also specify a sequence in which the fulfillment user should visit the retailer locations.

The order management module 220 may track the location of the fulfillment user through the fulfillment user client device 110 to determine when the fulfillment user arrives at the retailer location. When the fulfillment user arrives at the retailer location, the order management module 220 transmits the order to the fulfillment user client device 110 for display to the fulfillment user. As the fulfillment user uses the fulfillment user client device 110 to collect items at the retailer location, the order management module 220 receives item identifiers for items that the fulfillment user has collected for the order. In some embodiments, the order management module 220 receives images of items from the fulfillment user client device 110 and applies computer-vision techniques to the images to identify the items depicted by the images. The order management module 220 may track the progress of the fulfillment user as the fulfillment user collects items for an order and may transmit progress updates to the requesting user client device 100 that describe which items have been collected for the requesting user's order.

In some embodiments, the order management module 220 tracks the location of the fulfillment user within the retailer location. The order management module 220 uses sensor data from the fulfillment user client device 110 or from sensors in the retailer location to determine the location of the fulfillment user in the retailer location. The order management module 220 may transmit to the fulfillment user client device 110 instructions to display a map of the retailer location indicating where in the retailer location the fulfillment user is located. Additionally, the order management module 220 may instruct the fulfillment user client device 110 to display the locations of items for the fulfillment user to collect, and may further display navigation instructions for how the fulfillment user can travel from their current location to the location of a next item to collect for an order.

The order management module 220 determines when the fulfillment user has collected all of the items for an order. For example, the order management module 220 may receive a message from the fulfillment user client device 110 indicating that all of the items for an order have been collected. Alternatively, the order management module 220 may receive item identifiers for items collected by the fulfillment user and determine when all of the items in an order have been collected. When the order management module 220 determines that the fulfillment user has completed an order, the order management module 220 transmits the delivery location for the order to the fulfillment user client device 110. The order management module 220 may also transmit navigation instructions to the fulfillment user client device 110 that specify how to travel from the retailer location to the delivery location, or to a subsequent retailer location for further item collection. The order management module 220 tracks the location of the fulfillment user as the fulfillment user travels to the delivery location for an order, and updates the requesting user with the location of the fulfillment user so that the requesting user can track the progress of their order. In some embodiments, the order management module 220 computes an estimated time of arrival for the fulfillment user at the delivery location and provides the estimated time of arrival to the requesting user.

In some embodiments, the order management module 220 facilitates communication between the requesting user client device 100 and the fulfillment user client device 110. As noted above, a requesting user may use a requesting user client device 100 to send a message to the fulfillment user client device 110. The order management module 220 receives the message from the requesting user client device 100 and transmits the message to the fulfillment user client device 110 for presentation to the fulfillment user. The fulfillment user may use the fulfillment user client device 110 to send a message to the requesting user client device 100 in a similar manner.

The order management module 220 coordinates payment by the requesting user for the order. The order management module 220 uses payment information provided by the requesting user (e.g., a credit card number or a bank account) to receive payment for the order. In some embodiments, the order management module 220 stores the payment information for use in subsequent orders by the requesting user. The order management module 220 computes a total cost for the order and charges the requesting user that cost. The order management module 220 may provide a portion of the total cost to the fulfillment user for servicing the order, and another portion of the total cost to the retailer.

The meal planning module 225 receives a request to generate a customized meal plan for a user of the online system 140. The meal planning module 225 generates a prompt to the LLM from the user. The meal planning module 225 generates an interface for the user to collect one or more categories of user preferences. The user preferences may fall into a variety of categories such as cuisine, number of family members, available equipment, diet, and effort level. The set of user preferences are those specified by the user (via checkbox) in the user interface (UI). The meal planning module 225 may also access past purchase data and the predicted inventory data associated with retailers from sources such as the data collection module 200 or the data store 240. The meal planning module 225 generates the prompt for the LLM based on the user preferences collected via the interface, as well as any additional information collected such as past purchase data and/or predicted inventory data. For example, a prompt may be “Create a personalized meal plan for user <UserID> considering their past purchases, preferences, and predicted inventory supply across multiple retailers,” where the user preferences received through the interface, order history, and predicted inventory supply are included as contextual information in the prompt. The prompt may be text-based. In some embodiments, the prompt may include images, such as photos of past meals or preferred ingredients, to provide additional context and information. The output received from the LLM may include a variety of formats representing a personalized meal plan, such as an interactive meal plan calendar or a shopping list.

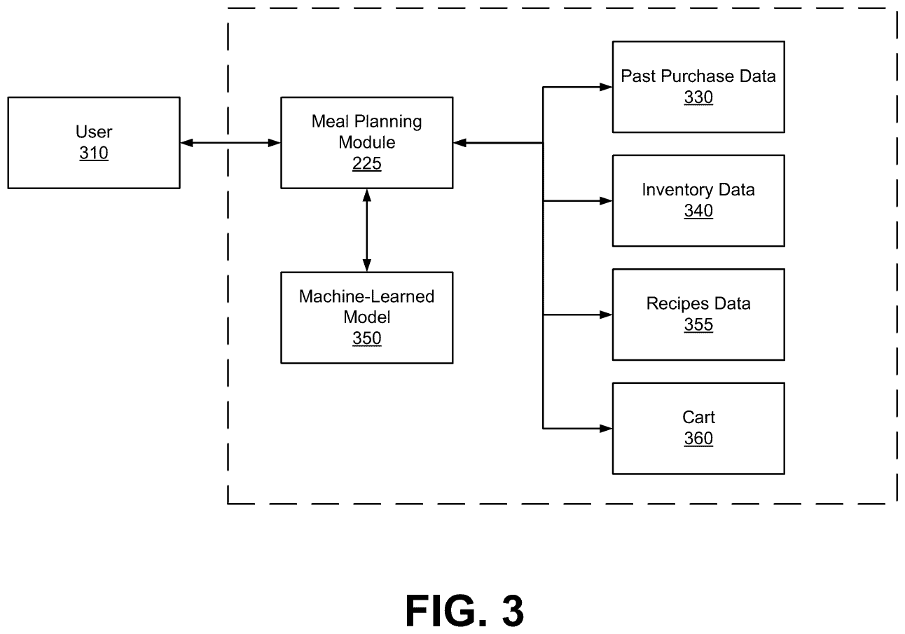

FIG. 3 is a block diagram for a method of meal planning, in accordance with some embodiments. Alternative embodiments may include more, fewer, or different elements from those illustrated in FIG. 3, and the steps may be performed in a different order from that illustrated in FIG. 3. These steps may be performed by an online system (e.g., online system 140, e.g., via the meal planning module 225). Additionally, each of these steps may be performed automatically by the online system without human intervention.

The meal planning module 225 generates an interface to a user 310 of an online system 140. In one or more embodiments, the interface is generated by the meal planning module 225 providing instructions including textual components, graphical components, or other user interface components, for rendering the user interface to a client device 100. The interface presents one or more categories of preferences for the user 310 for a personalized meal plan for the user. The requesting user client device 100 displays the interface for the user 310. User preferences may fall into a variety of categories such as cuisine, number of family members, available equipment, diet, and effort level.

The meal planning module 225 receives, from the user 310, a set of user preferences for the personalized meal plan via the interface. The set of user preferences are those specified by the user (via checkbox) in the user interface (UI) or other collection method via a user interface. The meal planning module 225 may also access collected data from sources such as data collection module 200 or the data store 240. The meal planning module 225 may access the past purchase data 330 and the inventory data 340 associated with retailers in order to consider past user behavior and available ingredients in the prompt.

The meal planning module 225 generates a prompt for execution by a machine-learned model. The prompt includes at least a request to generate the personalized meal plan for the user and the set of user preferences as contextual information. For example, a prompt may be, “Create a personalized meal plan for user <UserID> considering their past purchases, preferences, and predicted inventory supply across multiple retailers.” The prompt may be text-based. In some embodiments, the prompt may include images, such as photos of past meals or preferred ingredients, to provide additional contextual information. The meal planning module 225 provides the prompt to the machine-learning model 320.

The meal planning module 225 receives, as output from the machine-learning model 320, a personalized meal plan that comprises a list of meals for the user to consume during a duration of time and for each meal, a list of ingredients for making the meal. The output from the machine-learning model 320 includes at least a list of meals. The output received from the machine-learning model 320 may include a variety of formats representing a personalized meal plan, such as such as an interactive meal plan calendar (e.g., Meal 1 for breakfast on Day 1, Meal 2 for lunch on Day 1, Meal 3 for dinner on Day 1, Meal 4 for breakfast on Day 2, and so on) or a shopping list. In some embodiments, the output from the machine-learning model 320 includes information such as recipe instructions and a photo of the meals. In other embodiments, further prompts to the machine-learning model 320 may be needed for further information such as recipe instructions and a photo of the meal. The output from the machine-learning model 320 may be provided to the meal planning module 225 to generate further prompts such as a prompt for recipe instructions or a photo of the meal.

The meal planning module 225 generates recipes for making the list of meals based on the list of ingredients for the list of meals. The generation of recipes by the meal planning module 225 based on the output of the machine-learning model 320 ensures that the ingredients used in the recipes match the dietary restrictions and user preferences from the user 310. In some embodiments, the meal planning module 225 generates recipes via the machine-learning model 320, using the previously output list of meals as input, to create the output of human-usable recipes. The prompt to the machine-learning model 320 to generate recipes may include specific guidelines relating to such dietary restrictions from the user preferences received from the user 310. In some embodiments, previously generated recipes are stored in the recipes data 350. In response to a meal in the list of meals that has a recipe previously generated (e.g., from a previous meal planning generation session), the meal planning module 225 may retrieve the previously generated recipe from the recipes data 350. The generated recipes may also include generated photos of the meal to be made. In some embodiments, the machine-learning model 320 generates a photo of the meal based on a prompt for a photo of the meal and previous output from the machine-learning model 320 such as the meal title.

The meal planning module 225 provides to the user 310 the personalized meal plan via the requesting user client device 100. In some embodiments, the meal planning module 225 may provide to the user interface the option to edit or change meals included in the meal plan for further customization by the user 310. Responsive to a selection of a meal by user 310, the meal planning module 225 presents an ordering interface displaying at least one retailer and a list of items for the retailer. The list of items for the retailer corresponds to the list of ingredients for the personalized meal plan for the user to order. Thus, the meal planning module 225 may operate in conjunction with other modules of the online system 140 to map the ingredient(s) in a personalized meal plan for a user to existing items for sale by the retailer and generate an ordering interface, such that the user can easily and quickly order required ingredients for the meal plan.

In some embodiments, all items from the list of items associated with the personalized meal plan are added to cart 360. In some embodiments, the meal planning module 225 may, based on the past purchase data 330, determine which ingredients the user 310 already has and so may only add to the cart 360 the remaining items of the list that the user 310 still needs to purchase. In some embodiments, the meal planning module 225 provides a selection of multiple possible retailers which have the list of items available, and receives from the user 310 a selection of which retailer to use for the order. Rather than add the list of items to the cart 360, the list of items may also be saved as a list to the account associated with user 310.

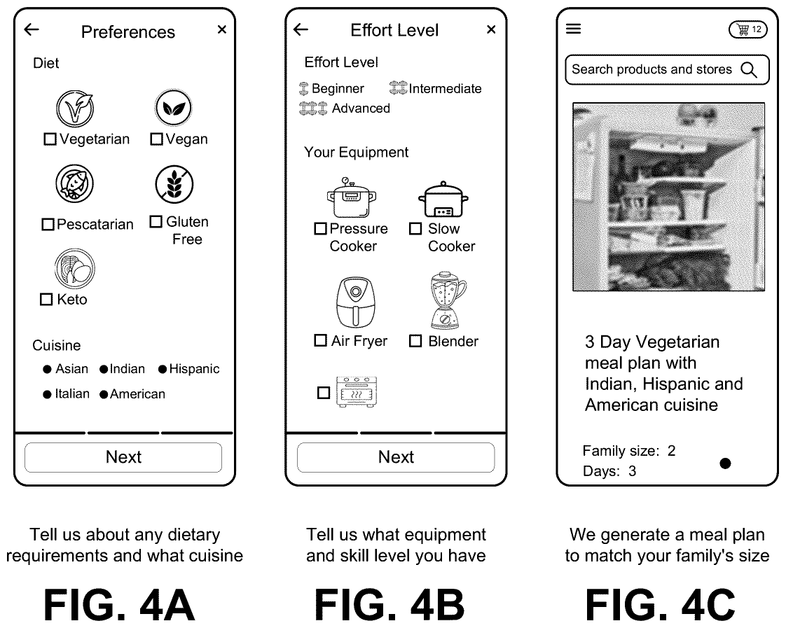

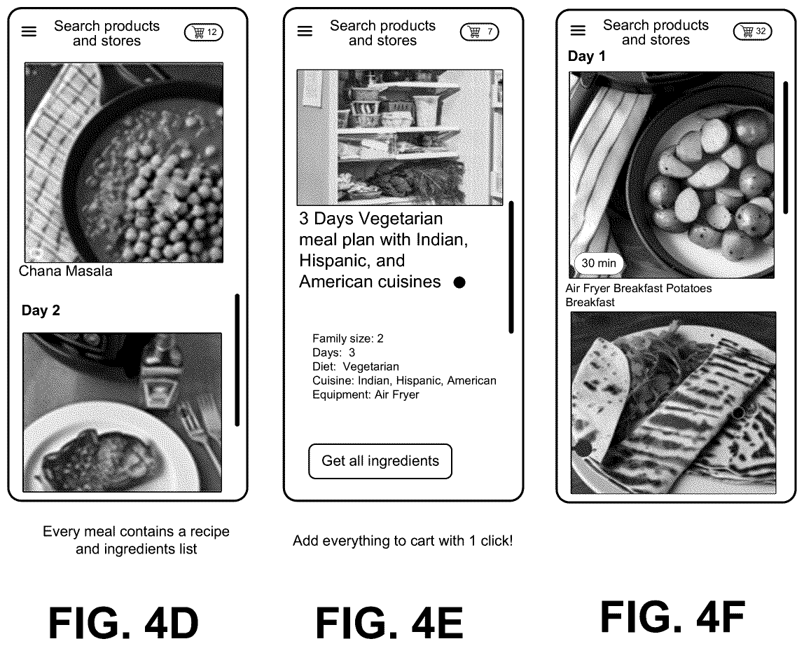

FIGS. 4A-4F illustrate example user interfaces presented by the online system for meal planning, in accordance with some embodiments. FIGS. 4A and 4B show an interface for the user to select preferences from a range of categories of user preferences. The categories for user preferences include categories such as cuisine, number of family members, available equipment, diet, and effort level. FIG. 4C shows a user interface displaying the output from the machine-learning model 320 with an interactive meal plan including a list of meals. The example shown in FIG. 4C is an introductory description of a meal plan over three days that has vegetarian dietary restrictions with Indian, Hispanic, and American cuisine.

FIG. 4D shows a user interface displaying the list of meals by day over the duration of time designated by the user 310 as part of user preferences. FIG. 4E shows a user interface including a selection by the user 310 to order the ingredients associated with the meal plan. In response to the selection by the user 310 shown in FIG. 4E, the user 310 may have the option to select a retailer, add the list of the items to the cart 360, and/or save the list of items to the account of the user 310 for purchase at a later time. FIG. 4F shows additional variations of similar interfaces and screenshots as included in FIGS. 4A-4E.

The meal planning module 225 generates a first interface on a client device of a user, the first interface presenting one or more categories of preferences for the user for a personalized meal plan for the user. Some examples of a first interface include the screenshots shown in FIGS. 4A and 4B. The meal planning module 225 obtains a set of user preferences from the user via the first interface. The meal planning module 225 obtains a personalized meal plan for the user based at least on the set of user preferences as contextual information, wherein the personalized meal plan includes a list of meals, and a list of ingredients based on each of the meals in the list of meals.

The meal planning module 225 generates a second interface on the client device configured to display the personalized meal plan, wherein the display of the personalized meal plan comprises the list of meals and images of meals. Some examples of a second interface include the screenshots from FIGS. 4C and 4D. The meal planning module 225, responsive to receiving interaction by the user to order ingredients associated with one or more displayed meals, obtains a list of items for one or more retailers that correspond to the ingredients of the one or more meals.

The meal planning module 225 generates a third interface on the client device to order ingredients associated with the personalized meal plan based on the list of items and the list of meals. An example of a third interface includes the screenshots shown in FIG. 4E.

The machine-learning training module 230 trains machine-learning models used by the online system 140. For example, the machine-learning module 230 may train the item selection model, the availability model, or any of the machine-learned models deployed by the model serving system 150. The online system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers.

Each machine-learning model includes a set of parameters. A set of parameters for a machine-learning model are parameters that the machine-learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include requesting user data, fulfillment user data, item data, or order data. In some cases, the training examples also include a label which represents an expected output of the machine-learning model. In these cases, the machine-learning model is trained by comparing its output from input data of a training example to the label for the training example.

The machine-learning training module 230 may apply an iterative process to train a machine-learning model whereby the machine-learning training module 230 trains the machine-learning model on each of the set of training examples. To train a machine-learning model based on a training example, the machine-learning training module 230 applies the machine-learning model to the input data in the training example to generate an output. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross-entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online system 140. For example, the data store 240 stores requesting user data, item data, order data, and fulfillment user data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

### Example Methods

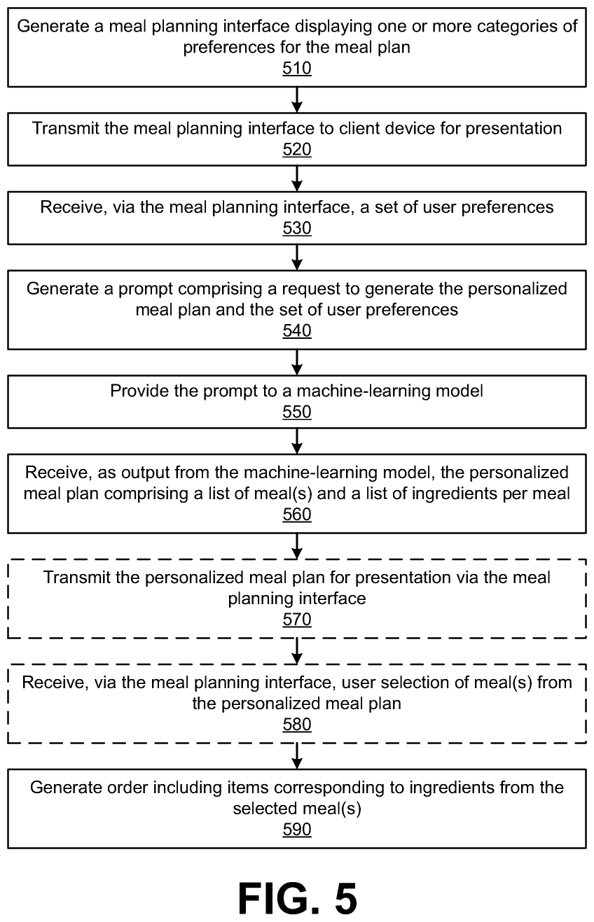

FIG. 5 is a flowchart for a method of meal planning, in accordance with some embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

The online system 140 generates 510 a meal planning interface displaying one or more categories of preferences for the meal plan. The interface may be arranged as tiles, wherein each tile presents a category and options associated with the category.

The online system 140 transmits 520 the meal planning interface to a client device associated with the user for presentation to the user.

The online system 140 receives 530, via the meal planning interface, a set of user preferences. The set of user preferences may indicate diet regimes, dietary preference, cuisine preference, portion sizes, allergies, etc.

In some embodiments, the online system 140 may retrieve other contextual information. In one or more embodiments, the online system 140 may retrieve historical order data indicating past orders by the user. In other embodiments, the online system 140 may retrieve inventory data of retailers hosted by the online system. In other embodiments, the online system 140 may retrieve user feedback from the user on past meal plans crafted. In other embodiments, the online system 140 may retrieve information on items in a pending order of the user or items in a cart in use by the user.

The online system 140 generates 540 a prompt for execution by a machine-learned model, the prompt comprising a request to generate the personalized meal plan and the set of user preferences. The online system 140 may generate the prompt to further include the other contextual information.

The online system 140 provides 550 the prompt to the machine-learning model for execution. The machine-learning model may be a LLM trained on a large corpus of training data to generate outputs for natural language processing tasks. In general, a LLM leverages probabilistic analysis of unstructured data, to train the model to recognize distinctions between textual components. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture). To fine tune the LLM, the online system 140 may generate training examples based on user feedback. For example, if the output of the LLM is positively or negatively received, the online system 140 may generate positive and/or negative training examples to fine tune the LLM, i.e., to maximize likelihood of output similar to the positive training examples and/or to minimize likelihood of output similar to the negative training examples.

The online system 140 receives 560, as output from the machine-learning model, the personalized meal plan comprising a list of one or more meals and a list of ingredients per meal. The personalized meal plan may further include a recipe for each meal, e.g., indicating steps to prepare the meal, an expected time for preparation of the meal, an expected level of effort (and/or difficulty) in preparation of the meal, etc.

In some embodiments, the online system 140 transmits 570 the personalized meal plan for presentation via the meal planning interface. From the interface, the user may engage with the personalized meal plan. For example, the user may select or approve of one or more of the meals presented. The user may also request modifications to the meals presented, etc. Modifications may include substitution of ingredient(s), adding ingredient(s), removing ingredient(s), increasing portion size, etc. The online system 140 may generate a subsequent prompt including the modifications to the personalized meal plan, i.e., for execution by the machine-learning model.

In some embodiments, the online system 140 receives 580, via the meal planning interface, user selection of one or more meals from the personalized meal plan. In other embodiments, the online system 140 may perform selection of the meals from the personalized meal plan for an upcoming time period. The online system 140 may identify items in an item catalog that correspond to the ingredients of the selected meals.

The online system 140 generates 590 an order including the identified items corresponding to ingredients for the selected one or more meals. If an order was already pending, the online system 140 may append the lists of ingredients to the pending order. For example, any items on the lists of ingredients not yet added to the order would be added. In embodiments with the user operating a cart in the retailer location, the online system 140 may add the lists of ingredients to a shopping list of the user, e.g., to guide the user in obtaining the remaining ingredients.

In one or more embodiments, following the user's preparation of one or more of the meals in the personalized meal plan, the online system 140 may prompt the user to provide feedback to the meal planning method. The user may provide feedback rating their enjoyment of the personalized meal plan, indicating whether the level of effort or the amount of time matched the expectations, etc. The online system 140 may leverage the feedback in fine-tuning the machine-learning model.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present), and B is false (or not present), A is false (or not present), and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present), and C is false (or not present). Similarly, as another not-limiting example, the condition “A, B, or C” is satisfied when A is true (or present), and B and C are false (or not present).

What is claimed is:

1. A method implemented by a computer processor executing instructions stored on a non-transitory computer-readable storage medium, the method comprising:
transmitting instructions for presenting a user interface on a client device, the user interface displaying one or more categories of preferences for a user for generating a personalized meal plan for the user of the client device;
receiving, via the user interface presented on the client device, a set of user preferences for the personalized meal plan;
generating a prompt for execution by a machine-learned model trained as a large language model on a large corpus of training data to perform natural language processing tasks, the prompt comprising at least a request to generate the personalized meal plan for the user and the set of user preferences;
providing the prompt to the machine-learning model for execution;
receiving, as output from the machine-learning model, the personalized meal plan for the user comprising a list of one or more meals for the user and a list of ingredients for making each meal;
selecting one or more meals from the personalized meal plan for an upcoming time period;
identifying one or more items in an item catalog corresponding to the ingredients for the one or more meals selected from the personalized meal plan; and
generating an order including the items identified in the item catalog for the user to order from one or more retailer locations.

2. The method of claim 1, wherein transmitting the instructions for presenting the user interface comprises:
transmitting instructions for generating one or more tiles to present the categories of preferences for the personalized meal plan, wherein each tile comprises one category of preferences and options associated with the category.

3. The method of claim 1, further comprising:
obtaining historical order data for the user indicating one or more historical orders requested by the user, wherein each historical order includes one or more items obtained from one or more retailer locations,
wherein generating the prompt comprises including the historical order data in the prompt.

4. The method of claim 1, further comprising:
obtaining inventory data from one or more retailer locations indicating inventory of items available at the retailer locations,
wherein generating the prompt comprises including the inventory data in the prompt.

5. The method of claim 1, further comprising:
generating a recipe for each meal based on a list of ingredients for the meal; and
transmitting instructions for presenting the recipes for the list of meals in the personalized meal plan for presentation to the user.

6. The method of claim 1, further comprising:
transmitting instructions for presenting the list of one or more meals of the personalized meal plan on the client device to the user via the user interface; and
receiving, via the user interface presented on the client device, user input selecting one or more meals from the personalized meal plan,
wherein selecting the one or more meals from the personalized meal for the upcoming time period is based on the user input.

7. The method of claim 6, wherein transmitting the instructions for presenting the list of one or more meals of the personalized meal plan on the client device to the user via the user interface includes instructions to display one or more options for inputting one or more modifications to the personalized meal plan, the method further comprising:
receiving, via the user interface, user input comprising one or more modifications to the personalized meal plan; and
modifying the personalized meal plan based on the user input.

8. The method of claim 7, wherein modifying the personalized meal plan comprises:
generating a subsequent prompt for execution by the machine-learning model, wherein the subsequent prompt comprises the personalized meal plan and the one or more modifications from the user input;
providing the subsequent prompt to the machine-learning model for execution; and
receiving, as subsequent output from the machine-learning model, a modified personalized meal plan.

9. The method of claim 1, further comprising:
transmitting instructions for presenting an ordering interface including the order including the items identified in the item catalog on the client device; and
receiving, via the ordering interface presented on the client device, user input submitting the order for fulfillment.

10. The method of claim 9, further comprising:
receiving, via the ordering interface presented on the client device, user input to modify the order; and
modifying the order based on the user input to modify the order.

11. The method of claim 1, further comprising:
receiving user feedback on the personalized meal plan; and
training the machine-learning model based on the user feedback.

12. A non-transitory computer-readable storage medium storing instructions that, when executed by a computer processor, cause the computer processor to perform operations comprising:
transmitting instructions for presenting a user interface on a client device, the user interface displaying one or more categories of preferences for a user for generating a personalized meal plan for the user of the client device;
receiving, via the user interface presented on the client device, a set of user preferences for the personalized meal plan;
generating a prompt for execution by a machine-learned model trained as a large language model on a large corpus of training data to perform natural language processing tasks, the prompt comprising at least a request to generate the personalized meal plan for the user and the set of user preferences;
providing the prompt to the machine-learning model for execution;
receiving, as output from the machine-learning model, the personalized meal plan for the user comprising a list of one or more meals for the user and a list of ingredients for making each meal;
selecting one or more meals from the personalized meal plan for an upcoming time period;
identifying one or more items in an item catalog corresponding to the ingredients for the one or more meals selected from the personalized meal plan; and
generating an order including the items identified in the item catalog for the user to order from one or more retailer locations.

13. The non-transitory computer-readable storage medium of claim 12, wherein transmitting the instructions for presenting the user interface comprises:
transmitting instructions for generating one or more tiles to present the categories of preferences for the personalized meal plan, wherein each tile comprises one category of preferences and options associated with the category.

14. The non-transitory computer-readable storage medium of claim 12, the operations further comprising:
obtaining historical order data for the user indicating one or more historical orders requested by the user, wherein each historical order includes one or more items obtained from one or more retailer locations,
wherein generating the prompt comprises including the historical order data in the prompt.

15. The non-transitory computer-readable storage medium of claim 12, the operations further comprising:
obtaining inventory data from one or more retailer locations indicating inventory of items available at the retailer locations,
wherein generating the prompt comprises including the inventory data in the prompt.

16. The non-transitory computer-readable storage medium of claim 12, the operations further comprising:
transmitting instructions for presenting the list of one or more meals of the personalized meal plan on the client device to the user via the user interface; and
receiving, via the user interface presented on the client device, user input selecting one or more meals from the personalized meal plan,
wherein selecting the one or more meals from the personalized meal for the upcoming time period is based on the user input.

17. The non-transitory computer-readable storage medium of claim 16, wherein transmitting the instructions for presenting the list of one or more meals of the personalized meal plan on the client device to the user via the user interface includes instructions to display one or more options for inputting one or more modifications to the personalized meal plan, the operations further comprising:
receiving, via the user interface, user input comprising one or more modifications to the personalized meal plan; and
modifying the personalized meal plan based on the user input.

18. The non-transitory computer-readable storage medium of claim 17, wherein modifying the personalized meal plan comprises:
generating a subsequent prompt for execution by the machine-learning model, wherein the subsequent prompt comprises the personalized meal plan and the one or more modifications from the user input;
providing the subsequent prompt to the machine-learning model for execution; and
receiving, as subsequent output from the machine-learning model, a modified personalized meal plan.

19. The non-transitory computer-readable storage medium of claim 12, the operations further comprising:
transmitting instructions for presenting the ordering interface including the order including the ingredients for the one or more meals on the client device; and
receiving, via the ordering interface presented on the client device, user input submitting the order.

20. A system comprising:
a computer processor; and
a non-transitory computer-readable storage medium storing instructions that, when executed by the computer processor, cause the computer processor to perform operations comprising:
transmitting instructions for presenting a user interface on a client device, the user interface displaying one or more categories of preferences for a user for generating a personalized meal plan for the user of the client device;
receiving, via the user interface presented on the client device, a set of user preferences for the personalized meal plan;
generating a prompt for execution by a machine-learned model trained as a large language model on a large corpus of training data to perform natural language processing tasks, the prompt comprising at least a request to generate the personalized meal plan for the user and the set of user preferences;
providing the prompt to the machine-learning model for execution;
receiving, as output from the machine-learning model, the personalized meal plan for the user comprising a list of one or more meals for the user and a list of ingredients for making each meal;
selecting one or more meals from the personalized meal plan for an upcoming time period;
identifying one or more items in an item catalog corresponding to the ingredients for the one or more meals selected from the personalized meal plan; and
generating an order including the items identified in the item catalog for the user to order from one or more retailer locations.
